(19) United States
(12) Patent Application Publication
(10) Pub. No.: US 2024/0141795 A1
(43) Pub. Date: May 2, 2024

(54) FLOW SPLITTER

(71) Applicant: ROLLS-ROYCE plc, London (GB)

(72) Inventor: Samuel P. LEE, Derby (GB)

(73) Assignee: ROLLS-ROYCE plc, London (GB)

(21) Appl. No.: 18/488,377

(22) Filed: Oct. 17, 2023

(30) Foreign Application Priority Data
Oct. 31, 2022 (GB) 2216057.6

(51) Int. Cl. F01D 9/04

(52) U.S. Cl. CPC F01D 9/04; F05D 2240/121; F05D 2250/73

(57) ABSTRACT

Described herein is a flow splitter for a gas turbine engine, the flow splitter comprising a leading edge, wherein the radial and/or axial position of the leading edge varies circumferentially around the flow splitter, such that the leading edge is non-axisymmetric. Also described is a method of manufacture of a flow splitter and an engine comprising a flow splitter.

### CROSS-REFERENCE TO RELATED PATENT APPLICATIONS

This application is based upon and claims the benefit of priority from UK Patent Application No. GB 2216057.6, filed on 31 Oct. 2022, the entire contents of which are herein incorporated by reference.

### BACKGROUND

### Technical Field

The present disclosure relates to a component for splitting the flow of a fluid passing through a gas turbine engine.

### Description of Related Art

Existing components for splitting fluids in gas turbine engines may result in aerodynamic loss and poor flow and pressure uniformity. It will be understood that improvements in components for splitting fluids are desirable.

### SUMMARY

According to a first aspect of the present disclosure, there is provided a flow splitter for a gas turbine engine, the flow splitter comprising a leading edge, wherein the radial and/or axial position of the leading edge varies circumferentially around the flow splitter, such that the leading edge is non-axisymmetric.

The flow splitter may be a component for splitting a fluid in in a fluid flow path of the engine. The fluid flow path may extend generally axially in a downstream direction.

The gas turbine engine may have a rotational axis. The leading edge may be non-axisymmetric about the rotational axis of the engine. By providing a non-axisymmetric flow splitter, the flow characteristics in the region of the strut may be improved.

Non-axisymmetric may mean that the flow splitter does not have continuous cylindrical symmetry. The flow splitter may have discrete rotational symmetry. The flow splitter may have discrete rotational symmetry about a rotational axis of the engine.

A plurality of flow splitters may be arranged to form a flow splitter ring. The flow splitter ring may be substantially annular. A flow splitter may form a substantially annular sector of the flow splitter ring. Each flow splitter in a flow splitter ring may be manufactured separately and subsequently joined. The flow splitter ring may comprise a plurality of flow splitters which are integrally formed.

The flow splitter may comprise a connection portion for attachment to a strut of the gas turbine engine. The connection portion may be a surface of the flow splitter.

The flow splitter may be attached to a strut. The flow splitter may be manufactured separately from the strut and subsequently joined. The flow splitter may be integrally formed with the strut.

The strut may have a leading edge and a trailing edge. The strut may be for positioning in a fluid flow path of an engine. The strut may affect the flow in the fluid flow path. There may be a plurality of struts in an engine. The strut or struts may be arranged in the intermediate casing of an engine. The strut or struts may be arranged between the fan and a compressor of an engine.

The strut may have a chord extending generally axially. The strut may have a height extending radially. The strut may extend radially between an outer wall sector and an inner wall sector. The strut may be integrally formed with the outer and/or inner wall sectors.

A plurality of struts and outer and/or inner wall sectors may be arranged to form a substantially annular strut ring. The struts and outer and/or inner wall sectors may be manufactured separately and subsequently joined. The strut ring may be integrally formed in one-piece. The struts may provide structural support. The struts may provide structural support between the outer and inner walls.

The strut may define an internal passageway in the radial direction. Services for the engine may be passed through the internal passageway.

The outer wall may be an outer casing of a gas turbine engine. The inner wall may be an engine core hub. The strut may transfer structural load between the outer casing and the engine core hub. The internal passageway of the strut may carry services between the outer casing and the engine core hub.

A radial distance of the leading edge from a rotational axis of the engine may be increased proximate the connection portion relative to a portion of the leading edge away from the connection portion.

The leading edge proximate the connection portion may be downstream relative to a portion of the leading edge away from the connection portion. The leading edge proximate the connection portion may be downstream of a leading edge of the strut. The leading edge proximate the connection portion may be in a mid-chord position of the strut. The leading edge may be axially swept away from the connection portion.

The leading edge may be symmetrical about the strut. The portion of the leading edge away from the connection portion may be a mid-passage portion.

The flow splitter may be for a fluid flow path defined between an outer casing and an engine core of the gas turbine engine, and the flow splitter may comprise an outer surface and an inner surface joined at the leading edge. The outer surface may be configured to form a hub of the outer casing and the inner surface may be configured to form a casing of the engine core.

The fluid flow path may be a fluid flow path from a fan of the engine. The flow splitter may be for being arranged between a fan and a compressor in the engine. The outer and inner surfaces of the splitter may extend downstream of the leading edge and split the flow into a bypass flow and a core flow.

According to a second aspect of the present disclosure, there is described a flow splitter ring comprising a plurality of flow splitters in accordance with the first aspect.

According to a third aspect of the present disclosure, there is described a method of manufacture of a flow splitter in accordance with the first aspect or a flow splitter ring in accordance with the second aspect, comprising designing a path of the leading edge and manufacturing the flow splitter or flow splitter ring based upon the designed path.

Designing a path of the leading edge may comprise analysing a fluid flow in a fluid flow path around the strut and optimising the path of the leading edge based upon the analysed fluid flow path. The method may further comprise designing a path of the upper and/or lower surface of the flow splitter. Designing a path of the upper and/or lower surface may comprise analysing a fluid flow in a fluid flow path around the strut and optimising the path of the upper and/or lower surface based upon the analysed fluid flow path. The method may be a computer implemented method.

According to a fourth aspect of the present disclosure, there is provided a gas turbine engine for an aircraft, the gas turbine engine comprising the flow splitter of the first aspect or the flow splitter ring of the second aspect.

According to a fifth aspect of the present disclosure, there is provided an aircraft comprising a gas turbine engine according to the third aspect.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only by the first core shaft, and not the second core shaft, in the example above). Alternatively, the gearbox may be arranged to be driven by any one or more shafts, for example the first and/or second shafts in the example above.

The gearbox may be a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, or 3.2 to 3.8, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. Purely by way of example, the gearbox may be a “star” gearbox having a ratio in the range of from 3.1 or 3.2 to 3.8. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of 0.4, 0.39, 0.38, 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e., the values may form upper or lower bounds), for example in the range of from 0.28 to 0.32. These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e., the portion radially outside any platform. The radius of the fan may be measured between the engine centreline and the tip of a fan blade at its leading edge. The fan diameter (which may simply be twice the radius of the fan) may be greater than (or on the order of) any of: 210 cm, 220 cm, 230 cm, 240 cm, 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 cm (around 150 inches), 390 cm (around 155 inches), 400 cm, 410 cm (around 160 inches) or 420 cm (around 165 inches). The fan diameter may be in an inclusive range bounded by any two of the values in the previous sentence (i.e. the values may form upper or lower bounds), for example in the range of from 210 cm to 240 cm, or 250 cm to 280 cm, or 320 cm to 380 cm.

The rotational speed of the fan may vary in use. Generally, the rotational speed is lower for fans with a higher diameter. Purely by way of non-limitative example, the rotational speed of the fan at cruise conditions may be less than 2600 rpm, for example less than 2500 rpm, or less than 2300 rpm. Purely by way of further non-limitative example, the rotational speed of the fan at cruise conditions for an engine having a fan diameter in the range of from 210 cm to 300 cm (for example 240 cm to 280 cm or 250 cm to 270 cm) may be in the range of from 1700 rpm to 2600 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 330 cm to 380 cm may be in the range of from 1200 rpm to 2000 rpm, for example in the range of from 1300 rpm to 1800 rpm, for example in the range of from 1400 rpm to 1800 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.28, 0.29, 0.30, 0.31, 0.32, 0.33, 0.34, 0.35, 0.36, 0.37, 0.38, 0.39 or 0.4 (all values being dimensionless). The fan tip loading may be in an inclusive range bounded by any two of the values in the previous sentence (i.e., the values may form upper or lower bounds), for example in the range of from 0.28 to 0.31, or 0.29 to 0.3.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds), for example in the range of form 12 to 16, 13 to 15, or 13 to 14. The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest-pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds), for example in the range of from 50 to 70.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range bounded by any two of the values in the previous sentence (i.e., the values may form upper or lower bounds), for example in the range of from 80 Nkg⁻¹ s to 100 Nkg⁻¹ s, or 85 Nkg⁻¹ s to 95 Nkg⁻¹ s. Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 130 kN, 135 kN, 140 kN, 145 kN, 150 kN, 155 kN, 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e., the values may form upper or lower bounds).

Purely by way of example, a gas turbine as described and/or claimed herein may be capable of producing a maximum thrust in the range of from 155 kN to 170 kN, 330 kN to 420 kN, or 350 kN to 400 kN. The thrust referred to above may be the maximum net thrust at standard atmospheric conditions at sea level plus 15 degrees C. (ambient pressure 101.3 kPa, temperature 30 degrees C.), with the engine static.

In use, the temperature of the flow at the entry to the high-pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1520K, 1530K, 1540K, 1550K, 1600K or 1650K. The TET at cruise may be in an inclusive range bounded by any two of the values in the previous sentence (i.e., the values may form upper or lower bounds), for example 1530K to 1600K. The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e., the values may form upper or lower bounds), for example in the range of from 1800K to 1950K, or 1900K to 2000K. The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium-based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN. The fan of a gas turbine as described and/or claimed herein may have any desired number of fan blades, for example 14, 16, 18, 20, 22, 24 or 26 fan blades.

As used herein, cruise conditions have the conventional meaning and would be readily understood by the skilled person. Thus, for a given gas turbine engine for an aircraft, the skilled person would immediately recognise cruise conditions to mean the operating point of the engine at mid-cruise of a given mission (which may be referred to in the industry as the “economic mission”) of an aircraft to which the gas turbine engine is designed to be attached. In this regard, mid-cruise is the point in an aircraft flight cycle at which 50% of the total fuel that is burned between top of climb and start of descent has been burned (which may be approximated by the midpoint—in terms of time and/or distance—between top of climb and start of descent). Cruise conditions thus define an operating point of the gas turbine engine that provides a thrust that would ensure steady state operation (i.e. maintaining a constant altitude and constant Mach Number) at mid-cruise of an aircraft to which it is designed to be attached, taking into account the number of engines provided to that aircraft. For example, where an engine is designed to be attached to an aircraft that has two engines of the same type, at cruise conditions the engine provides half of the total thrust that would be required for steady state operation of that aircraft at mid-cruise.

In other words, for a given gas turbine engine for an aircraft, cruise conditions are defined as the operating point of the engine that provides a specified thrust (required to provide—in combination with any other engines on the aircraft—steady state operation of the aircraft to which it is designed to be attached at a given mid-cruise Mach Number) at the mid-cruise atmospheric conditions (defined by the International Standard Atmosphere according to ISO 2533 at the mid-cruise altitude). For any given gas turbine engine for an aircraft, the mid-cruise thrust, atmospheric conditions and Mach Number are known, and thus the operating point of the engine at cruise conditions is clearly defined.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be part of the cruise condition. For some aircraft, the cruise conditions may be outside these ranges, for example below Mach 0.7 or above Mach 0.9.

Purely by way of example, the cruise conditions may correspond to standard atmospheric conditions (according to the International Standard Atmosphere, ISA) at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to a forward Mach number of 0.8 and standard atmospheric conditions (according to the International Standard Atmosphere) at an altitude of 35000 ft (10668 m). At such cruise conditions, the engine may provide a known required net thrust level. The known required net thrust level is, of course, dependent on the engine and its intended application and may be, for example, a value in the range of from 20 kN to 40 kN.

Purely by way of further example, the cruise conditions may correspond to a forward Mach number of 0.85 and standard atmospheric conditions (according to the International Standard Atmosphere) at an altitude of 38000 ft (11582 m). At such cruise conditions, the engine may provide a known required net thrust level. The known required net thrust level is, of course, dependent on the engine and its intended application and may be, for example, a value in the range of from 35 kN to 65 kN.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

According to an aspect, there is provided an aircraft comprising a gas turbine engine as described and/or claimed herein. The aircraft according to this aspect is the aircraft for which the gas turbine engine has been designed to be attached. Accordingly, the cruise conditions according to this aspect correspond to the mid-cruise of the aircraft, as defined elsewhere herein.

According to an aspect, there is provided a method of operating a gas turbine engine as described and/or claimed herein. The operation may be at the cruise conditions as defined elsewhere herein (for example in terms of the thrust, atmospheric conditions and Mach Number).

According to an aspect, there is provided a method of operating an aircraft comprising a gas turbine engine as described and/or claimed herein. The operation according to this aspect may include (or may be) operation at the mid-cruise of the aircraft, as defined elsewhere herein.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close-up sectional side view of an upstream portion of a gas turbine engine;

FIG. 3 is a partially cut-away view of a gearbox for a gas turbine engine;

FIG. 4 is a cross-sectional view of a portion of a gas turbine engine comprising a flow splitter;

FIGS. 5a and 5b are front and perspective views of a flow splitter, respectively; and

FIG. 6 is a cross-sectional view in an axial direction of a flow splitter ring comprising a plurality of flow splitters in an engine;

FIGS. 7a and 7b are sectional views along the lines marked S_{A} and S_{B} in FIG. 6; and

FIG. 8 is a flow chart for a method in accordance with the invention.

### DETAILED DESCRIPTION

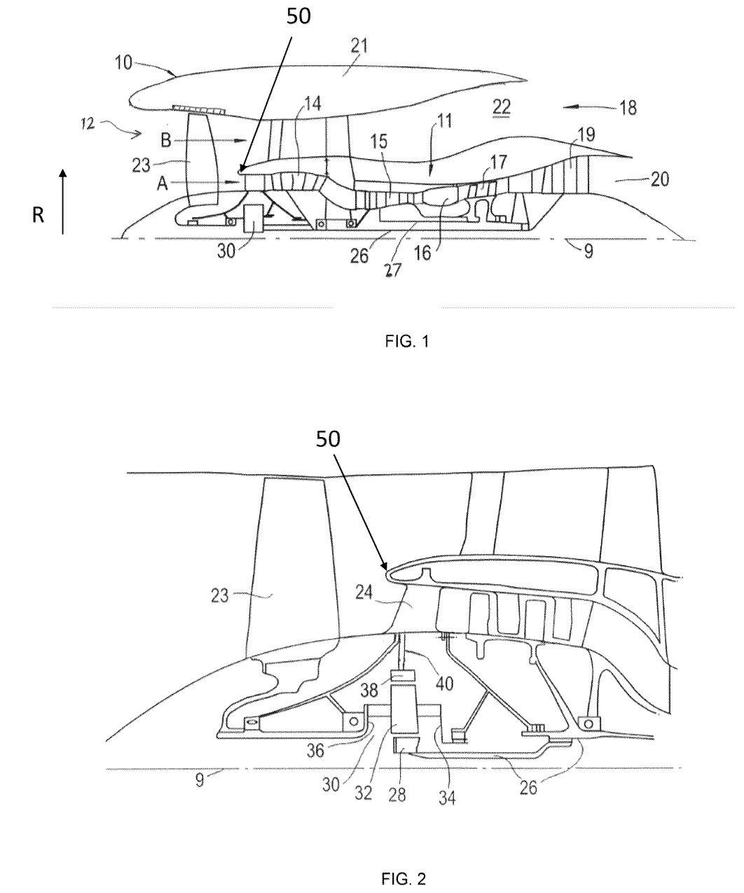

Referring now to FIG. 1 which illustrates a gas turbine engine 10 having a principal rotational axis 9. The engine 10 comprises an air intake 12 and a propulsive fan 23 that generates two airflows: a core airflow A and a bypass airflow B. The airflow from the propulsive fan 23 is split into the core airflow A and bypass airflow B by means of a flow splitter 50. The gas turbine engine 10 comprises a core 11 that receives the core airflow A. The engine core 11 comprises, in axial flow series, a low-pressure compressor 14, a high-pressure compressor 15, combustion equipment 16, a high-pressure turbine 17, a low-pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low-pressure turbine 19 via a shaft 26 and an epicyclic gearbox 30.

In use, the core airflow A is accelerated and compressed by the low-pressure compressor 14 and directed into the high-pressure compressor 15 where further compression takes place. The compressed air exhausted from the high-pressure compressor 15 is directed into the combustion equipment 16 where it is mixed with fuel and the mixture is combusted. The resultant hot combustion products then expand through, and thereby drive, the high pressure and low-pressure turbines 17, 19 before being exhausted through the nozzle 20 to provide some propulsive thrust. The high-pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low-pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e., not including the fan 23) respectively and/or the turbine and compressor stages that are connected together by the interconnecting shaft 26 with the lowest rotational speed in the engine (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

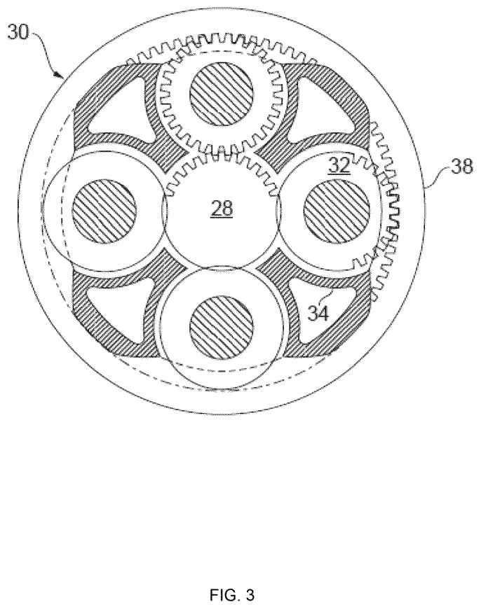

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g., the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction L (which is aligned with the rotational axis 9), a radial direction R (in the bottom-to-top direction in FIG. 1), and a circumferential direction (perpendicular to the page in the FIG. 1 view). The axial, radial and circumferential directions are mutually perpendicular.

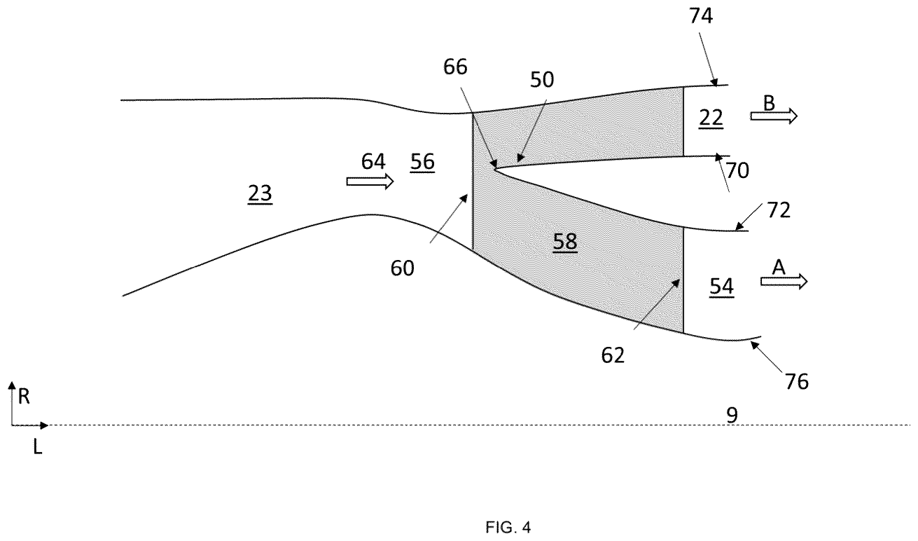

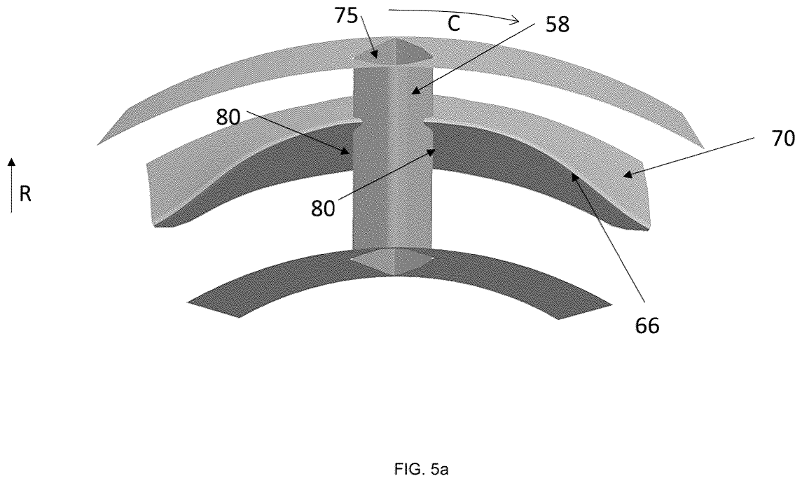

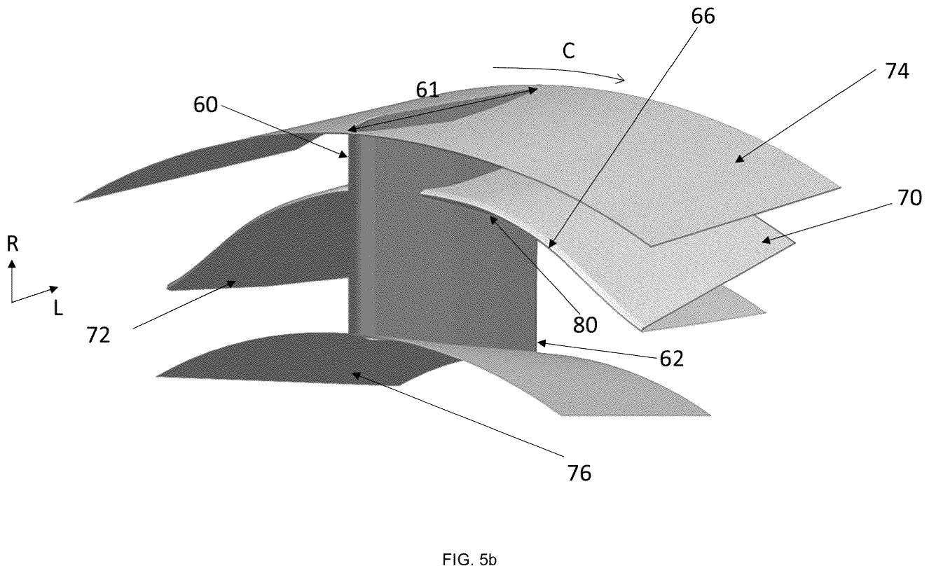

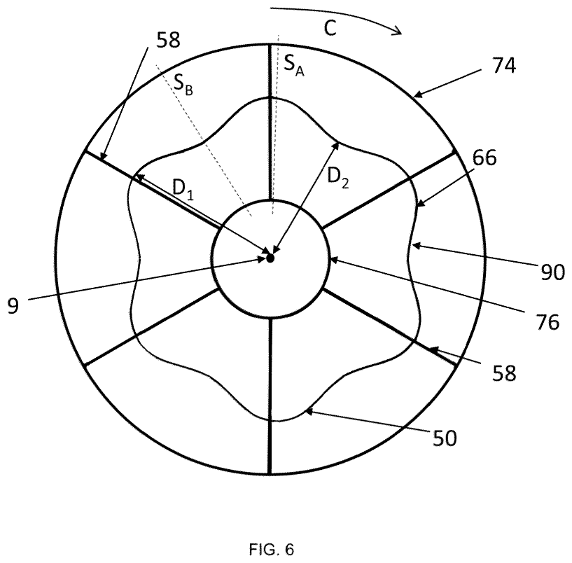

Referring now to FIGS. 4, 5a and 5b a flow splitter 50 of the gas turbine engine is shown.

FIG. 4 is a partial cross-sectional view showing the passage of air through the engine 10 and the location of a flow splitter 50. Fan airflow 64 from the fan 23 (fan blades not shown in FIG. 4) passes through the fan duct 56 in a generally axial direction L, the arrows indicating the direction of air flow. The fan airflow 64 is then split by the flow splitter 50 into a bypass air flow B which passes into the bypass duct 22, and a core airflow A which passes into the core duct 54, to a compressor as described above.

The fan duct 56 is defined between an outer casing 74 and an inner hub 76. A plurality of supporting struts 58 are also arranged between the outer casing 74 and inner hub 76, which is an engine core hub. In this example, the strut 58 is integrally formed with the outer casing 74 and/or inner hub 76 but in other examples may be formed separately and joined. An internal passageway 75 of the strut 58 is defined in the radial direction R for the passage of services for the engine 10 from the outer casing 64 to the inner hub 76.

The strut 58 comprises a leading edge 60 and a trailing edge 62. The strut 58 has a chord 61 extending generally axially and a height extending radially. The height of the strut 58 varies in the axial direction. Although only one supporting strut 58 is shown in FIG. 4, it will be appreciated that a plurality of struts 58 are disposed circumferentially around the engine 10 (also see FIG. 6).

The flow splitter 50 is shown in more detail in FIGS. 5a and 5b. The flow splitter 50 is attached to a strut 58 and comprises a leading edge 66 at which an outer surface 70 and inner surface 72 meet. The flow splitter 50 is symmetrical about a centreline of the flow splitter 50. The outer surface 70 forms a hub of the outer casing and the inner surface 72 forms a casing of the engine core. The flow splitter 50 has two connection portions 80 (or connection surfaces) for attachment to a strut 58 of the gas turbine engine 10. In use, the strut 58 is located between the two connection portions 80. The connection portion 80 will be in contact with the strut 58 when in use. In this example, the flow splitter 50 is manufactured separately from the strut 58 and subsequently joined. In other examples, the flow splitter 50 and strut 58 may be manufactured integrally.

As seen in these Figures, the radial and axial position of the leading edge 66 of the flow splitter 50 varies circumferentially (i.e., in a circumferential direction C) around the flow splitter 50, such that the leading edge 66 is non-axisymmetric. It will be understood that, although the rotational axis 9 of the engine is not shown in FIGS. 5a and 5b, the leading edge 66 is non-axisymmetric about the rotational axis 9 of the engine. In other words, the leading edge 66 does not have continuous cylindrical symmetry about the rotational axis 9.

The flow splitter 50 has discrete rotational symmetry about the rotational axis 9 of the engine as will be further described in relation to the flow splitter ring 90 below. In this example, both the radial and axial position of the leading edge varies circumferentially, but in other examples, it may be that only one of the radial and axial positions may be varied.

The strut 58 affects the flow of the fan airflow 64 in the fluid flow path, such that the airflow is not axisymmetric. The effects of the strut 58 and the airflow around the strut 58 may be dependent upon changes in engine speed and air flow through the engine 10. The inventors have found that by providing a non-axisymmetric flow splitter 50, the flow characteristics in the region of the strut 58 may be improved. Flow separation may be inhibited and loading on the endwalls (i.e., the outer casing and the inner hub) of the duct 56 may be reduced, which may help to minimise aerodynamic loss and improve flow uniformity at the fan exit. Further, with improved flow characteristics it may be possible to reduce the length of the bypass and core ducts 22, 54 and reduce the weight of the engine 10. This may result in more efficient operation of the engine.

As shown in FIGS. 5a, 5b and 6, a radial distance D of the leading edge 66 from a rotational axis 9 of the engine 10 may be increased proximate the connection portion 80 relative to a portion of the leading edge away from the connection portion 80. In other words, the distance D₁ (FIG. 6) from the rotational axis 9 to the leading edge 66 of the flow splitter 50 near to the connection portion 80 (proximate the strut 58 in use), is greater than a distance D2 from the rotational axis 9 to the leading edge 66 of the flow splitter 50 further away from the connection portion 80 (such as in a position midway between two struts 58 as shown in FIG. 6). The radial distance D of the leading edge 66 from the rotational axis 9 is therefore greater in a region near to the strut 58 than a mid-passage section away from the strut 58. It is important to note that this is only one example of a non-axisymmetric leading edge 66 in accordance with the invention, and in other examples the radial distance D of the leading edge 66 from the rotational axis 9 may be smaller proximate the connection portion 80 than further away.

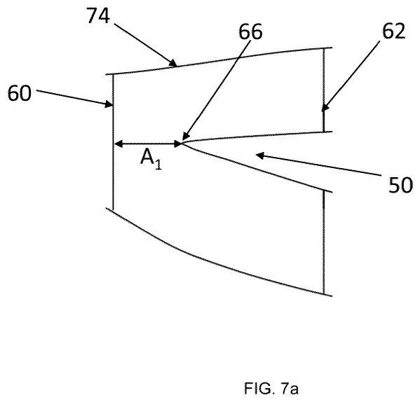

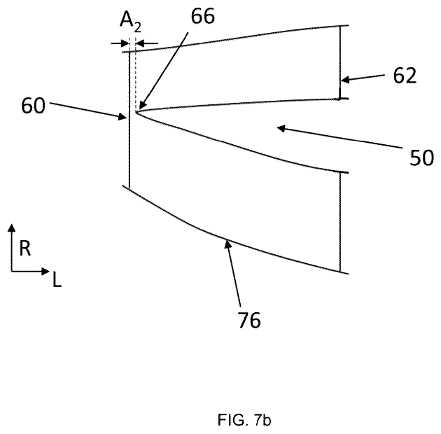

FIGS. 7a and 7b show sections taken along the lines S_{A} and S_{B} of FIG. 6. Section S_{A} is taken proximate the connection portion 80 and is shown in FIG. 7a. Section S_{B} is taken away from the connection portion 80 and is shown in FIG. 7b.

It will be appreciated that in use, air flows in the direction L shown in FIGS. 7a and 7b, and therefore that the leading edge 66 proximate the connection portion 80 is downstream relative to a portion of the leading edge away from the connection portion 80.

In the example shown, the leading edge 66 of the flow splitter 58 is shown as being downstream of the leading edge 60 of the strut 58 in both the circumferential positions shown in FIGS. 7a and 7b, and an axial distance of the leading edge 66 of the flow splitter 50 from the leading edge 60 of the strut 58 is defined by A. It will be appreciated that in other examples, the leading edge 66 of the flow splitter 50 may be arranged upstream of the leading edge 60 of the strut 58 at any desired circumferential position.

In the example shown, the distance A₁ (FIG. 7a) between the leading edge 60 of the strut 58 and the leading edge 66 of the flow splitter 50 near to the connection portion 80 (proximate the strut 58 in use), is greater than a distance A₂ (FIG. 7b) between the leading edge 60 of the strut 58 and the leading edge 66 of the flow splitter 50 further away from the connection portion 80 (such as in a position midway between two struts 58 as shown in FIG. 6). The leading edge 66 of the flow splitter 50 proximate the connection portion 80 is in a mid-chord position of the strut 58 and the leading edge 66 of the flow splitter 50 may be described as being axially swept.

The distance A between the leading edge 66 of the flow splitter 50 and the leading edge 60 of the strut 58 is therefore greater in a region near to the strut 58 than a mid-passage section away from the strut 58. It is important to note that this, again, is only one example of a non-axisymmetric leading edge 66 in accordance with the invention, and in other examples the leading edge 66 proximate the connection portion 80 may be upstream relative to a portion of the leading edge 66 away from the connection portion 80. In an example, a distance A between the leading edge 66 of the splitter 50 and the leading edge 60 of the strut 58 may be smaller proximate the connection portion 80 than away from the connection portion 80).

In use, the engine 10 comprises a plurality of flow splitters 50 arranged in a ring 90 around the engine, as shown in a simplified view in FIG. 6. For simplicity, only the leading edges 66 of the flow splitters 50 are shown in FIG. 6, but it will be appreciated that each flow splitter 50 is substantially as shown in FIGS. 5a and 5b.

The flow splitter ring 90 is substantially annular and a single flow splitter 50 therefore forms a substantially annular sector of the flow splitter ring 90. The order of the rotational symmetry of the flow splitter 50 and the flow splitter ring 90 is therefore dependent upon the number of flow splitters required in the ring 90. This in turn may be dependent upon the number of struts 58 required in the engine 10. Although in the example shown, there are six flow splitters 50 arranged in a ring 90, with six struts 58, it will be appreciated that a lower or higher number of struts 58 and flow splitters 50, for example four or eight, may be used dependent upon the design of the engine 10.

In some examples, each flow splitter 50 in a flow splitter ring 90 is manufactured separately and subsequently joined. In other examples, the plurality of flow splitters 50 are integrally formed, such that the flow splitter ring 90 is effectively a single, continuous flow splitter which encircles the engine core 11.

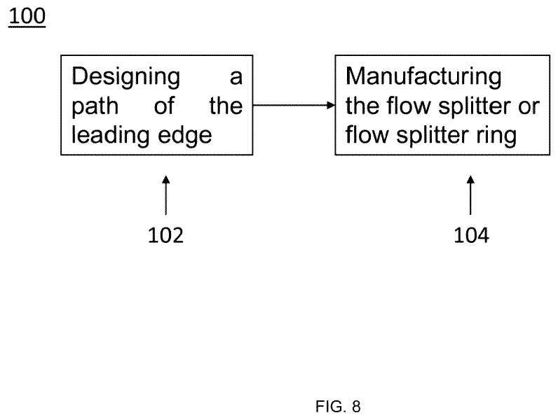

A method 100 of manufacture of a flow splitter 50 or a flow splitter ring 90 will now be described, with reference to FIG. 8. A first step 102 comprises designing a path of the leading edge of the flow splitter 50 or flow splitter ring 90. The step 102 of designing a path of the leading edge 66 may be carried out with a computer and may comprise modelling the geometry of the strut 58 and analysing a fluid flow in a fluid flow path around the strut 58. The method further comprises optimising the path of the leading edge 66 based upon the analysed fluid flow path.

A second step 104 comprises manufacturing the flow splitter 50 or flow splitter ring 90 based upon the designed path. After manufacture of the flow splitter 50 or flow splitter ring 90, it may be attached to a strut or struts 58 and installed in an engine 10 for use.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A flow splitter for a gas turbine engine, the flow splitter comprising a leading edge, wherein the radial and/or axial position of the leading edge varies circumferentially around the flow splitter, such that the leading edge is non-axisymmetric.

2. The flow splitter according to claim 1, wherein the flow splitter comprises a connection portion for attachment to a strut of the gas turbine engine.

3. The flow splitter according to claim 1, attached to a strut.

4. The flow splitter according to claim 2, wherein a radial distance of the leading edge from a rotational axis of the engine is increased proximate the connection portion relative to a portion of the leading edge away from the connection portion.

5. The flow splitter according to claim 2, wherein the leading edge proximate the connection portion is downstream relative to a portion of the leading edge away from the connection portion.

6. The flow splitter according to claim 1, wherein the flow splitter is for a fluid flow path defined between an outer casing and an engine core of the gas turbine engine, and wherein the flow splitter comprises an outer surface and an inner surface joined at the leading edge; wherein the outer surface is configured to form a hub of the outer casing and the inner surface is configured to form a casing of the engine core.

7. A flow splitter ring comprising a plurality of flow splitters according to claim 1.

8. A method of manufacture of a flow splitter ring according to claim 7, comprising designing a path of the leading edge and manufacturing the flow splitter ring based upon the designed path.

9. A method of manufacture of a flow splitter according to claim 1, comprising designing a path of the leading edge and manufacturing the flow splitter based upon the designed path.

10. The method according to claim 9, wherein designing a path of the leading edge comprises analysing a fluid flow in a fluid flow path around the strut and optimising the path of the leading edge based upon the analysed fluid flow path.

11. A gas turbine engine for an aircraft comprising a flow splitter according to claim 1.
